(19) United States
(12) Patent Application Publication
(10) Pub. No.: US 2012/0273076 A1
(43) Pub. Date: Nov. 1, 2012

(54) COMPACT HYDRAULIC ACCUMULATOR

(75) Inventor: Simon J. Baseley, Ann Arbor, MI (US)

(73) Assignee: ROBERT BOSCH GMBH, Stuttgart (DE)

(21) Appl. No.: 13/096,060

(22) Filed: Apr. 28, 2011

(51) Int. Cl. F16L 55/04

(52) U.S. Cl. 138/30

(57) ABSTRACT

An accumulator includes a non-cylindrical outer vessel defining a gas-filled interior chamber, and an inner member positioned in the gas-filled interior chamber. The inner member has a gas-receiving portion in fluid communication with the gas-filled interior chamber of the outer vessel for receiving gas, and a working fluid-receiving portion separate from the gas-receiving portion for receiving working fluid.

### BACKGROUND

The present invention relates to hydraulic accumulators and more particularly to hydraulic accumulators for use in hybrid hydraulic drive systems for vehicles.

A typical vehicle hybrid hydraulic drive system uses a reversible pump/motor to absorb power from and add power to or assist a conventional vehicle drive system. The system absorbs power by pumping working fluid (e.g., hydraulic fluid) from a low pressure reservoir into a hydraulic energy storage system. This hydraulic energy storage system typically includes one or more gas-charged hydraulic accumulators. Hybrid hydraulic drive systems typically add power to conventional vehicle drive systems by utilizing the hydraulic energy stored in the hydraulic accumulators to drive the reversible pump/motor as a motor.

Hydraulic accumulators traditionally have a cylindrical outer shell with substantially hemispherical ends. The shell contains an elastomeric bladder or a piston assembly within the cylindrical outer shell to separate the working fluid from the high pressure gas. This configuration, utilizing a cylindrical outer shell to accommodate the high pressure gas and the working fluid, provides good structural strength from a mechanical stress standpoint.

### SUMMARY

Conventional accumulators with the cylindrical outer shell present challenges in terms of packaging one or more accumulators in a vehicle having a hybrid hydraulic drive system. The cylindrical outer shells are not particularly suited for being tightly packaged with other components or for being clustered together in a minimal amount of space.

The present invention provides an improved compact hydraulic accumulator designed in a manner that enables the outer shell to have a non-cylindrical shape, therefore allowing for more efficient packaging within the confined space of a vehicle.

In one embodiment, the invention provides an accumulator including a non-cylindrical outer vessel defining a gas-filled interior chamber, and an inner member positioned in the gas-filled interior chamber. The inner member has a gas-receiving portion in fluid communication with the gas-filled interior chamber of the outer vessel for receiving gas, and a working fluid-receiving portion separate from the gas-receiving portion for receiving working fluid.

In another embodiment the invention provides an accumulator including an outer vessel defining a gas-filled interior chamber, an inner member positioned in the gas-filled interior chamber, and a bladder positioned within the inner member. The bladder defines a bladder interior in fluid communication with the gas in the gas-filled interior chamber of the outer vessel. A working fluid-receiving space between the bladder and an interior surface of the inner member is fluidly isolated from the bladder interior.

In yet another embodiment, the invention provides an accumulator including an outer vessel defining a gas-filled interior chamber and a first inner member positioned in the gas-filled interior chamber. The first inner member has a gas-receiving portion in fluid communication with the gas-filled interior chamber of the outer vessel for receiving gas, and a working fluid-receiving portion separate from the gas-receiving portion for receiving working fluid. The accumulator further includes a second inner member positioned in the gas-filled interior chamber. The second inner member has a gas-receiving portion in fluid communication with the gas-filled interior chamber of the outer vessel for receiving gas, and a working fluid-receiving portion separate from the gas-receiving portion for receiving working fluid. The working fluid-receiving portion of the first inner member and the working fluid-receiving portion of the second inner member are separate from each another within the outer vessel.

Other aspects of the invention will become apparent by consideration of the detailed description and accompanying drawings.

### BRIEF DESCRIPTION OF THE DRAWINGS

FIG. 1 is a schematic of a vehicle hybrid hydraulic drive system including a hydraulic accumulator embodying the present invention.

FIG. 2 is a longitudinal section view of a first embodiment of the hydraulic accumulator of FIG. 1.

FIG. 3 is a transverse section view of the hydraulic accumulator of FIG. 2 taken along line 3-3 in FIG. 2.

FIG. 4 is a longitudinal section view of a second embodiment of the hydraulic accumulator of FIG. 1.

FIG. 5 is a transverse section view of the hydraulic accumulator of FIG. 4 taken along line 5-5 in FIG. 4.

FIG. 6 is a longitudinal section view of a third embodiment of the hydraulic accumulator of FIG. 1.

FIG. 7 is a transverse section view of the hydraulic accumulator of FIG. 6 taken along line 7-7 in FIG. 6.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

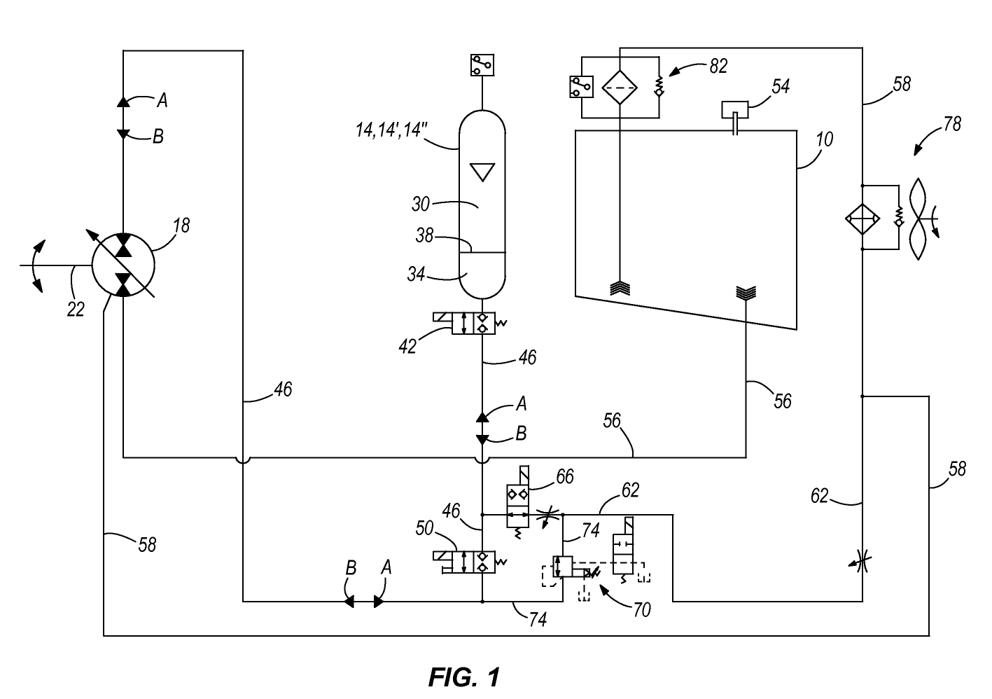

FIG. 1 illustrates a schematic of a vehicle hybrid hydraulic drive system including a reservoir 10, an accumulator 14 in selective fluid communication with the reservoir 10, and a reversible pump/motor 18 operably coupled to the accumulator 14. The reversible pump/motor 18 is operably coupled to a driveline 22 of a vehicle to deliver power to the vehicle driveline 22 or to absorb power from the vehicle driveline 22, as is understood by those skilled in the art.

The accumulator 14 is shown only schematically in FIG. 1, and includes a first chamber 30 containing a gas (e.g. nitrogen, etc.), a second chamber 34 containing a working fluid (e.g. hydraulic fluid, etc.), and a separating member 38 separating the chambers 30, 34 (schematically illustrated as a line between the chambers 30, 34). Further details of the accumulator 14 will be set forth below. The vehicle hybrid hydraulic drive system also includes an isolation valve 42 in fluid communication with the working fluid chamber 34 in the accumulator 14 by a fluid passageway. Alternatively, the isolation valve 42 may be mounted directly to an inlet/outlet port of the accumulator 14. The isolation valve 42 is also in fluid communication with the reversible pump/motor 18 by a fluid passageway 46. Another isolation valve 50 is in fluid communication with the isolation valve 42 and the reversible pump/motor 18 and is situated in the fluid passageway 46 between the isolation valve 42 and the reversible pump/motor 18. Each of the isolation valves 42, 50 is solenoid-actuated to open and spring-biased to close. Each of the isolation valves described below may be structurally and functionally similar to the isolation valves 42, 50. Further, each of the isolation valves described below, including isolation valves 42, 50, may be controlled by an engine control unit (“ECU”) of the vehicle or by a control unit that is separate and distinct from the ECU.

With continued reference to FIG. 1, the reservoir 10 contains working fluid and includes a breather 54. The breather 54 provides venting of the space above the working fluid in the reservoir 10 as the level of working fluid fluctuates during operation of the vehicle hybrid hydraulic drive system. The breather 54 is exposed to the atmosphere, such that gas in the reservoir 10 may be vented to the atmosphere, and replacement air may be allowed to enter the reservoir 10 when the level of working fluid in the reservoir 10 decreases.

The reservoir 10 is in fluid communication with the reversible pump/motor 18 by separate fluid passageways 56, 58. Another isolation valve 66 is situated in a fluid passageway 62 joining the fluid passageway 46 and the fluid passageway 58. In addition, a pressure relief valve 70 is in fluid communication with the reversible pump/motor 18 and the reservoir 10 and is situated in a fluid passageway 74 between the reversible pump/motor 18 and the reservoir 10. The fluid passageway 74 fluidly communicates the respective passageways 46, 62 when the pressure relief valve 70 is opened. A heat exchanger 78 and a working fluid filter 82 are in fluid communication with the reversible pump/motor 18 and the reservoir 10 and are each situated in the fluid passageway 58 between the reversible pump/motor 18 and the reservoir 10.

When the vehicle undergoes braking or another operation where rotational energy (e.g., from the engine or driveline 22) may be absorbed and stored, the reversible pump/motor 18 functions as a pump driven by the engine or vehicle's axle or driveline 22. The reversible pump/motor 18 draws low-pressure working fluid from the reservoir 10 through the fluid passageway 56 and pressurizes the working fluid. The resultant high pressure working fluid exits the reversible pump/motor 18 and flows through the fluid passageway 46 (in the direction of arrow A), through the isolation valves 50, 42 and into the working fluid chamber 34 of the accumulator 14. As the pressurized working fluid flows into the accumulator 14, the separating member 38 is displaced, thereby compressing the gas in the gas chamber 30. The work performed by the separating member 38 to compress the gas is stored for later use to power the driveline 22.

When the vehicle undergoes acceleration or another operation where propulsion assistance is needed, the reversible pump/motor 18 functions as a motor. The compressed gas acts on the separating member 38 in the accumulator 14, thereby maintaining the working fluid at a high pressure. Upon opening the isolation valves 42, 50, pressurized working fluid flows from the accumulator 14 in the direction of arrow B, through the fluid passageway 46 and into the reversible pump/motor 18 to drive the reversible pump/motor 18 and the driveline 22, thereby assisting the vehicle's acceleration or other energy-expending operation. After being used by the pump/motor 18, low-pressure working fluid exits the reversible pump/motor 18, flows through the working fluid passageway 58, through the heat exchanger 78 and the filter 82 positioned in the fluid passageway 58, and is subsequently returned to the reservoir 10.

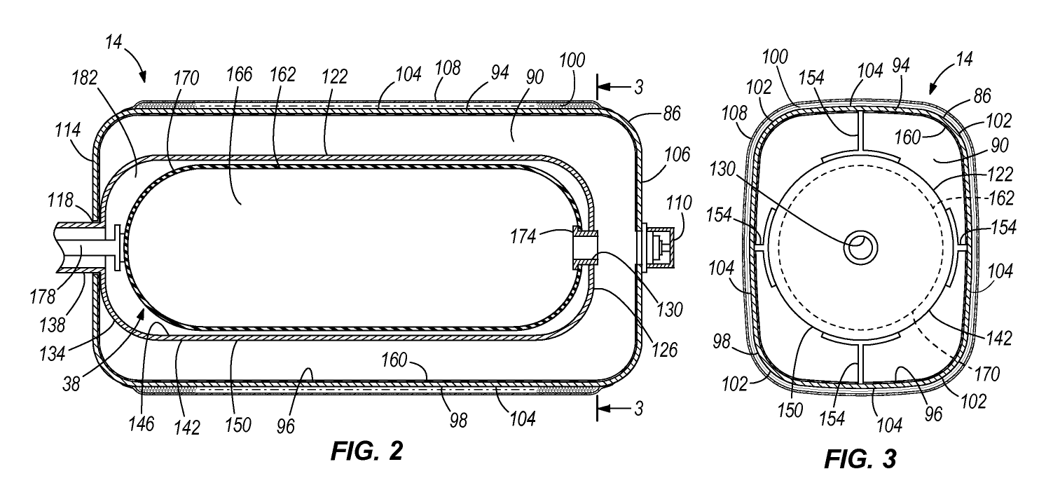

FIGS. 2 and 3 show a first embodiment of the accumulator 14. Unlike conventional accumulators having a cylindrical outer shell or vessel, which typically result in wasted, empty space and therefore less efficient packaging in the vehicle, the accumulator 14 includes an outer, non-cylindrical vessel 86 that defines a gas-filled interior chamber 90 (part of the gas chamber 30 represented schematically in FIG. 1). The outer, non-cylindrical vessel 86 includes a former 94 having an interior surface 96 defining the chamber 90 and an exterior surface 98. The vessel 86 also includes fiber 100 wound about the exterior surface 98 of the former 94 to reinforce the former 94 and to provide additional hoop strength to the former 94. In the illustrated construction of the vessel 86, a matrix material 108 at least partially covers the fiber 100 to protect the fiber 100 from the surrounding environment of the accumulator 14. In constructing the vessel 86, the matrix material 108 may be impregnated in the fiber 100, and a curing process may be employed to heat the vessel 86 to cause the matrix material 108 to flow out of the fiber 100 and into the space between adjacent windings of the fiber 100 until the fiber 100 is substantially surrounded or encased by the matrix material 108. As shown in FIGS. 2 and 3, the former 94 is configured as a thin plastic structure having a thickness less than that of the wound fiber 100 and matrix material 108.

As shown in FIG. 3, the vessel 86 includes four arcuate surfaces 104, each being defined by a relatively large radius, and four arcuate corners 102 each connecting two adjacent surfaces 104. The radii of the corners 102 are substantially less than the radii of the surfaces 104, thereby imparting a generally rectangular shape to the accumulator 14. Such a non-cylindrical shape facilitates better packaging efficiency within the space provided in a vehicle for the accumulator 14. Additionally, if two accumulators 14 are used in the system, they can be more tightly packaged or nested together by virtue of the generally rectangular shape of the outer vessel 86 to minimize the space consumed.

With reference to FIG. 2, the outer vessel 86 further includes a generally closed end 106 having a charge valve 110 through which gas can be transferred into or removed from the gas-filled interior chamber 90. The outer vessel 86 also includes an open end 114 with an opening 118 through which the working fluid can pass into and out of the outer vessel 86, as will be described further below. The outer vessel 86 can be made from any number of different materials (e.g., metal, a composite material, etc.) having a strength sufficient to withstand the pressure of the gas within the gas-filled interior chamber 90.

The accumulator 14 further includes an inner member 122 positioned in the gas-filled interior chamber 90 of the outer vessel 86. The illustrated inner member 122 is cylindrical in shape and includes an open end 126, having an opening 130 therein, and a port-containing end 134, having a port 138 coupled thereto. The inner member 122 is defined by a wall 142 having an interior surface 146 and an exterior surface 150. The illustrated inner member 122 can be made from metal (e.g., steel), or a composite material.

With continued reference to FIG. 2, the inner member 122 is secured to the outer vessel 86 with the port 138 positioned in the opening 118 in the open end 114 of the outer vessel 86, thereby centering and locating the inner member 122 relative to the outer vessel 86. The interface between the port 138 and the opening 118 is sealed to prevent gas from escaping from the gas-filled interior chamber 90. Particularly, the accumulator 14 includes a gas seal 160 lining the interior surface 96 of the former 94 to inhibit leakage of gas through the former 94. The gas seal 160 also extends between the port 138 and the opening 118 to inhibit leakage of gas through the interface between the port 138 and the opening 118. One or more support members 154 (see FIG. 3—not shown in FIG. 2) extend between the exterior surface 150 of the wall 142 of the inner member 122 and the interior surface 96 of the former 94 of the outer vessel 86. The support members 154 position and center the inner member 122 within the gas-filled chamber 90. Gas in the gas-filled interior chamber 90 is present in the gap defined between the exterior surface 150 of the inner member 122 and the interior surface 96 of the former 94.

The accumulator 14 also includes an expandable bladder 162 positioned within the inner member 122. The bladder 162 defines a bladder interior 166 and a bladder exterior surface 170. The bladder 162 includes an inlet/outlet port 174 sealed to the open end 126 of the inner member 122, and in the illustrated embodiment is sealed to the opening 130, to fluidly communicate the bladder interior 166 with the gas-filled interior chamber 90 of the outer vessel 86. The accumulator 14 further includes an anti-extrusion valve 178 that maintains spacing between the bladder 162 and the port 138 of the inner member 122 during expansion of the bladder 162.

The operation of the accumulator 14 will now be described. Gas from the gas-filled interior chamber 90 communicates with the inner member 122 through the opening 130 in the open end 126. Because the inlet/outlet port 174 of the bladder 162 is sealed to the opening 130, the gas fills the bladder interior 166. Together, the inner member 122 and the bladder 162 define a gas-receiving portion of the inner member 122 that is filled with gas and that is in fluid communication with the gas-filled interior chamber 90.

Working fluid is received in a space 182 defined between the bladder exterior surface 170 and the interior surface 146 of the inner member 122. Therefore, the space 182 between the inner member 122 and the bladder 162 constitutes a working fluid-receiving portion (i.e., the working fluid chamber 34 represented schematically in FIG. 1) of the accumulator 14 that is separate or fluidly isolated from the chamber 90 or gas-receiving portion (i.e., no fluid communication exists between the working fluid-receiving portion and the gas-receiving portion). Separation between the gas and the working fluid is maintained by the bladder 162 and the seal between the inlet/outlet port 174 of the bladder 162 and the opening 130 of the inner member 122. In other words, the seal at the inlet/outlet port 174 prevents working fluid in the space 182 from leaking into the bladder interior 166 or the gas-filled interior chamber 90 of the outer vessel 86. Working fluid can enter and exit the space 182 (i.e., the working fluid-receiving portion) through the port 138.

As the reversible pump/motor 18 pumps working fluid into the space 182, the bladder 162 is collapsed, forcing the gas in the bladder interior 166 out of the bladder 162 and into the gas-filled interior chamber 90. The pressure of the gas increases due to the now-reduced volume of the overall gas-containing space. When the reversible pump/motor 18 is used as a motor, the isolation valves 42, 50 are opened, allowing the pressurized gas in the bladder interior 166 to expand, thereby forcing working fluid out of the space 182, through the port 138, and through the passageway 46 leading to the pump/motor 18. The anti-extrusion valve 178 prevents damage to the bladder 162 upon expulsion of the working fluid from the space 182. Pressure sensors (not shown) for both the gas and the working fluid can be coupled with the accumulator 14 to help ensure proper operation of the accumulator 14.

By virtue of this design, the pressure inside and outside the inner member 122 is substantially the same, thereby allowing the thickness of the wall 142, and therefore the overall weight of the inner member 122, to be reduced. Additionally, because the interior surface 96 of the former 94 of the outer vessel 86 does not come directly into contact with the working fluid, and therefore need not engage and form a seal with any separating member 38 (i.e., the bladder 162 in this embodiment), the outer vessel 86 can be non-cylindrical in shape to achieve the improved packaging efficiencies discussed above. As mentioned above, the outer vessel 86 can be made from a composite material having a strength sufficient to withstand the pressure of the gas within the gas-filled interior chamber 90. The former 94 of the outer vessel 86 can be formed in two halves that can be assembled and sealed around the inner member 122. Then, the fiber 100 may be wrapped around the former 94, and the accumulator 14 may be cured to cause the impregnated matrix material 108 to flow out of the fiber 100 to substantially surround, cover, or encase the fiber 100. Alternately, the outer vessel 86 can be formed as one piece around the inner member 122. With either method of manufacture, the inner member 122 contributes to the structural stiffness of the outer vessel 86 via the support members 154, which also do not interfere with the separating member 38 (i.e., the bladder 162 in this embodiment). Furthermore, while not shown, an access port could be formed in the outer vessel 86 near or in conjunction with the charge valve 110 to provide access to the gas-filled interior chamber 90 and the bladder 162.

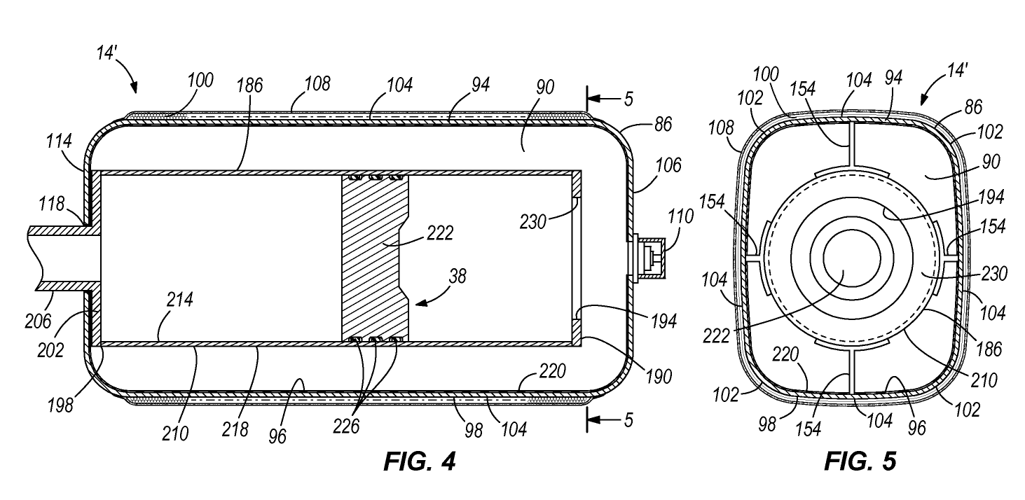

FIGS. 4 and 5 illustrate a second embodiment of the accumulator of FIG. 1 (labeled 14′). The outer vessel 86, including components coupled thereto like the charge valve 110 and the support members 154, are substantially the same as the outer vessel 86 of FIGS. 2 and 3, and like parts have been given like reference numbers. The accumulator 14′ has a modified inner member 186 and separating member arrangement.

The inner member 186 is positioned in the gas-filled interior chamber 90 of the outer vessel 86. The illustrated inner member 186 is cylindrical in shape and includes an open end 190 defining an opening 194 therein, and a closed end 198 that in the illustrated embodiment is substantially closed off by an end cap 202 that forms an end wall of the inner member 186. The end cap 202 has a port 206 coupled thereto. In the illustrated embodiment, the end cap 202 is formed to integrally define the port 206. The inner member 186 is further defined by a wall 210 that is sealed to the end cap 202. The wall 210 has an interior surface 214 and an exterior surface 218. The illustrated inner member 186 can be made from metal (e.g., steel), or a composite material.

The inner member 186 is secured to the outer vessel 86 with the port 206 positioned in the opening 118 in the open end 114 of the outer vessel 86, thereby centering and locating the inner member 186 relative to the outer vessel 86. The interface between the port 206 and the opening 118 is sealed to prevent gas from escaping from the gas-filled interior chamber 90. Particularly, the accumulator 14′ includes a gas seal 220 lining the interior surface 96 of the former 94 to inhibit leakage of gas through the former 94. The gas seal 220 also extends between the port 206 and the opening 118 to inhibit leakage of gas through the interface between the port 206 and the opening 118. One or more support members 154 (see FIG. 5—not shown in FIG. 4) extend between the exterior surface 218 of the wall 210 of the inner member 186 and the interior surface 96 of the former 94 of the outer vessel 86. The support members 154 position and center the inner member 186 within the gas-filled chamber 90.

The accumulator 14′ further includes a piston 222 positioned in the inner member 186 in sealing engagement with the interior surface 214 of the wall 210. The piston 222 can include seal rings 226 or other sealing features to provide a fluid-tight seal between a working fluid-receiving portion of the inner member 186 (to the left of the piston in FIG. 4) and a gas-receiving portion of the inner member 186 (to the right of the piston in FIG. 4). Thus, the piston 222 acts as the separating member 38 in the accumulator 14′ to separate the working fluid from the gas. In an construction of the accumulator 14′ in which the inner member 186 is made from metal (e.g., steel), the interior surface 214 can include a surface finish sufficient to facilitate reciprocation or sliding of the piston 222 during operation of the accumulator 14′. The inner member 186 further includes a piston stop 230 at the open end 190 that stops the piston 222 from moving out of the inner member 186 through the opening 194. The illustrated piston stop 230 is a ring coupled to the opening 194, but can also be a plurality of individual stop members or other suitable structure.

The operation of the accumulator 14′ will now be described. Gas from the gas-filled interior chamber 90 communicates with the inner member 186 through the opening 194 in the open end 190. The gas fills the inner member 186 in the space to the right side (as shown in FIG. 4) of the piston 222, thereby defining a gas-receiving portion of the inner member 186 that is filled with gas and that is in fluid communication with the gas-filled interior chamber 90. Working fluid is received in the inner member 186 in the space to the left side (as shown in FIG. 4) of the piston 222. Therefore, the inner member 186 and the piston 222 also define a working fluid-receiving portion (i.e., the working fluid chamber 34 represented schematically in FIG. 1) that is separate from the gas-receiving portion. Separation between the gas and the working fluid is maintained by the piston 222 and seal rings 226. Working fluid can enter and exit the inner member 186 (i.e., the working fluid-receiving portion) through the port 206.

As the reversible pump/motor 18 pumps working fluid into the inner member 186, the piston 222 moves to the right (as shown in FIG. 4), forcing the gas in the inner member 186 out of the open end 190 and into the gas-filled interior chamber 90. The pressure of the gas increases due to the now-reduced volume of the overall gas-containing space. When the reversible pump/motor 18 is used as a motor, the isolation valves 42, 50 are opened, allowing the pressurized gas in the inner member 186 to urge the piston 222 to the left (as shown in FIG. 4), thereby forcing working fluid out of the inner member 186, through the port 138, and through the passageway 46 leading to the pump/motor 18. Pressure sensors (not shown) for both the gas and the working fluid can be coupled with the accumulator 14′ to help ensure proper operation of the accumulator 14′.

By virtue of this design, the pressure inside and outside the inner member 186 is substantially the same, thereby allowing the thickness of the wall 210, and therefore the overall weight of the inner member 186, to be reduced. Additionally, because the interior surface 96 of the former 94 of the outer vessel 86 does not come directly into contact with the working fluid, and therefore need not engage and form a seal with any separating member 38 (i.e., the piston 222 in this embodiment), the outer vessel 86 can be non-cylindrical in shape to achieve the improved packaging efficiencies discussed above. As mentioned above, the outer vessel 86 can be made from a composite material having a strength sufficient to withstand the pressure of the gas within the gas-filled interior chamber 90. The former 94 of the outer vessel 86 can be formed in two halves that can be assembled and sealed around the inner member 186. Then, the fiber 100 may be wrapped around the former 94, and the accumulator 14 may be cured to cause the impregnated matrix material 108 to flow out of the fiber 100 to substantially surround, cover, or encase the fiber 100. Alternately, the outer vessel 86 can be formed as one piece around the inner member 186. With either method of manufacture, the inner member 186 contributes to the structural stiffness of the outer vessel 86 via the support members 154, which also do not interfere with the separating member 38 (i.e., the piston 222 in this embodiment).

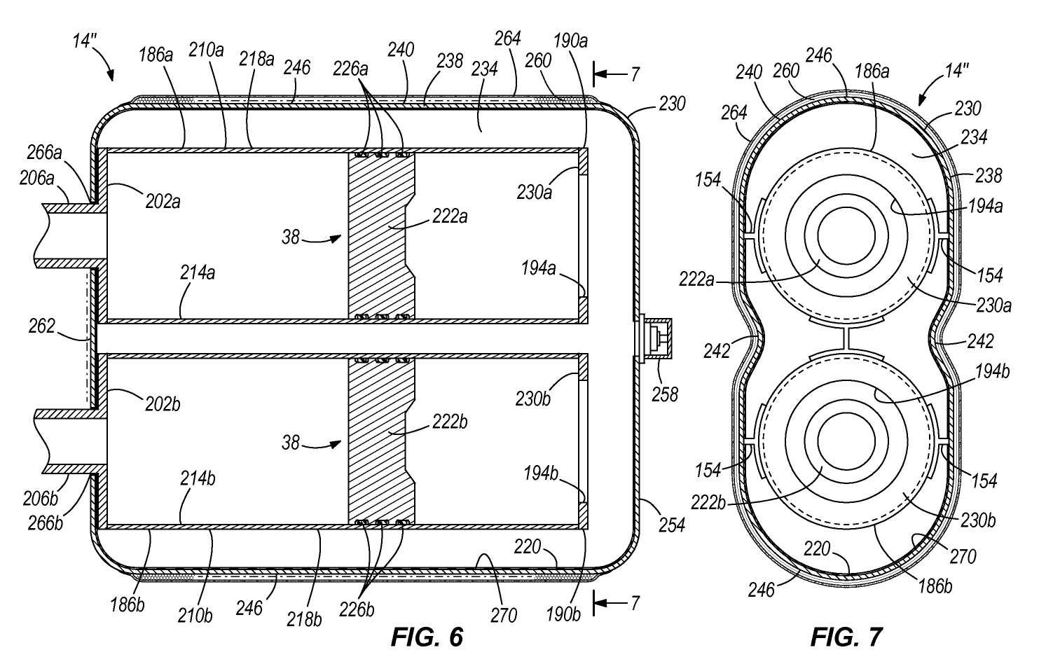

FIGS. 6 and 7 illustrate a third embodiment of the accumulator of FIG. 1 (labeled 14″). The accumulator 14″ includes two inner members 186 of the type described above with respect to the accumulator 14′ disposed within a single outer vessel 230. Components of the first and second inner members 186a and 186b have been given like reference numerals with the letters “a” and “b”. Each inner member 186a, 186b includes its own piston 222a, 222b, respectively, and functions in the same manner described above with respect to the inner member 186.

The outer, non-cylindrical vessel 230 defines a gas-filled interior chamber 234 (part of the gas chamber 30 represented schematically in FIG. 1) in which both inner members 186a, 186b are positioned. The outer vessel 230 includes a former 238 having an interior surface 270 defining the chamber 234 and an exterior surface 240. The exterior surface 240 includes two opposed arcuate surfaces 242 extending inwardly toward each other (see FIG. 7). The surfaces 242 facilitate better packaging efficiency within the space provided in a vehicle for the accumulator 14″. Additionally, if two accumulators 14″ are used in the system, they can be more tightly packaged or nested together by virtue of the surfaces 242 to minimize the space consumed. As shown in FIG. 7, the exterior surface 240 of the former 238 further includes at least one, and in the illustrated embodiment, two arcuate corners 246 defining rounded ends of the accumulator 14″. Each corner 246 provides a transition between two oppositely-facing arcuate surfaces 242.

The outer vessel 230 further includes a generally closed end 254 having a charge valve 258 through which gas can be transferred into or removed from the gas-filled interior chamber 234. The outer vessel 230 also includes an open end 262 with two openings 266a and 266b, corresponding with respective ports 206a and 206b of the inner members 186a, 186b, and through which the working fluid can pass into and out of the outer vessel 230. The outer vessel 230 can be made from any number of different materials (e.g., metal, a composite material, etc.) having a strength sufficient to withstand the pressure of the gas within the gas-filled interior chamber 234. Similar to the outer vessels 86 shown in FIGS. 2-5, the exterior surface 240 of the former 238 is wrapped with fiber 260 which, in turn, is substantially covered or encased by a matrix material 264. One or more support members 154 (see FIG. 7—not shown in FIG. 6) extend between the exterior surfaces 218a, 218b of the walls 210a, 210b of the inner members 186a, 186b and an interior surface 270 of the former 238 of the outer vessel 230. The support members 154 position and center the inner members 186a, 186b within the gas-filled chamber 90.

The operation of the accumulator 14″ will now be described. Gas from the gas-filled interior chamber 234 communicates with both of the inner members 186a, 186b through the respective openings 194a, 194b in the respective open ends 190a, 190b. The gas fills the inner members 186a, 186b to the right side (as shown in FIG. 6) of the pistons 222a, 222b, thereby defining a gas-receiving portion of each of the inner members 186a, 186b that is filled with gas and that is in fluid communication with the gas-filled interior chamber 234. Working fluid is received in each of the inner members 186a, 186b in the area to the left side (as shown in FIG. 6) of the pistons 222a, 222b. Therefore, the inner members 186a, 186b and the pistons 222a, 222b also define two separate working fluid-receiving portions within the outer vessel 230 that are separate from the respective gas-receiving portions and are also separate from one another. Separation between the gas and the working fluid in each inner member 186a, 186b is maintained by the respective pistons 222a, 222b and seal rings 226a, 226b. Working fluid can enter and exit the respective inner members 186a, 186b (i.e., the working fluid-receiving portions) through the respective ports 206a, 206b. This system can be particularly useful for systems having two separate working fluid circuits. Only a single outer vessel 230, defining a single gas-filled chamber 234 can be used to charge two separate inner members 186a, 186b that are contained within the gas-filled chamber 234, but that are in communication with two separate working fluid circuits (perhaps with two separate pump/motors 18). Space can therefore be conserved as compared to systems requiring two separate, conventional accumulators.

As the reversible pump/motor(s) 18 pumps working fluid into the inner members 186a, 186b, the respective pistons 222a, 222b move to the right (as shown in FIG. 6), forcing the gas in the inner members 186a, 186b out of the respective open ends 190a, 190b and into the gas-filled interior chamber 234. The pressure of the gas increases due to the now-reduced volume of the overall gas-containing space. When the reversible pump/motor(s) 18 is used as a motor, the isolation valves 42, 50 are opened, allowing the pressurized gas in the inner members 186a, 186b to urge the respective pistons 222a, 222b to the left (as shown in FIG. 6), thereby forcing working fluid out of the inner members 186a, 186b, through the respective ports 206a, 206b, and through the passageway(s) 46 leading to the pump/motor(s) 18. Pressure sensors (not shown) for both the gas and the working fluid (both working fluid-receiving portions) can be coupled with the accumulator 14″ to help ensure proper operation of the accumulator 14″.

By virtue of this design, the pressure inside and outside the inner members 186a, 186b is substantially the same, thereby allowing the thickness of the walls 210a, 210b, and therefore the overall weight of the inner members 186a, 186b, to be reduced. Additionally, because the wall 238 of the outer vessel 230 does not come directly into contact with the working fluid, and therefore need not engage and form a seal with any separating member 38 (i.e., the pistons 222a, 222b in this embodiment), the outer vessel 230 can be non-cylindrical in shape to achieve the improved packaging efficiencies discussed above. As mentioned above, the outer vessel 230 can be made from a composite material having a strength sufficient to withstand the pressure of the gas within the gas-filled interior chamber 234. The former 238 of the outer vessel 230 can be formed in two halves that can be assembled and sealed around the inner members 186a, 186b. Then, the fiber 260 may be wrapped around the former 238, and the accumulator 14″ may be cured to cause the impregnated matrix material 264 to flow out of the fiber 260 to substantially surround, cover, or encase the fiber 260. Alternately, the outer vessel 230 can be formed as one piece around the inner members 186a, 186b. With either method of manufacture, the inner members 186a, 186b contribute to the structural stiffness of the outer vessel 230 via the support members 154 , which also do not interfere with the separating members 38 (i.e., the pistons 222a, 222b in this embodiment).

While the accumulator 14″ is shown using the piston style inner members 186a, 186b, those skilled in the art will understand that a similar, dual-inner member accumulator could be constructed using two of the inner members 122 and two of the associated bladders 162 shown in the accumulator 14. The same or a similar outer vessel 230 could contain first and second inner members 122, that operate in the manner described above with respect to the accumulator 14, but that offer the ability to provide two separate working fluid-receiving portions that can communicate with two separate working fluid circuits, as described above with respect to the accumulator 14″.

While the accumulators 14, 14′, and 14″ are described above for use in a vehicle hybrid hydraulic drive system, it is to be understood that the accumulators 14, 14′, and 14″ can also be used in other applications. The accumulators 14, 14′,and 14″ each provide improved packaging and operating characteristics that can be useful for any application utilizing one or more accumulators.

Various features and advantages of the invention are set forth in the following claims.

1. An accumulator comprising:
a non-cylindrical outer vessel defining a gas-filled interior chamber; and
an inner member positioned in the gas-filled interior chamber, the inner member having a gas-receiving portion in fluid communication with the gas-filled interior chamber of the outer vessel for receiving gas, and a working fluid-receiving portion separate from the gas-receiving portion for receiving working fluid.

2. The accumulator of claim 1, wherein the non-cylindrical outer vessel includes at least one arcuate exterior surface.

3. The accumulator of claim 2, wherein the non-cylindrical outer vessel includes at least two arcuate exterior surfaces defined by different radii.

4. The accumulator of claim 1, wherein the non-cylindrical outer vessel includes
a former having an interior surface defining the gas-filled interior chamber and an exterior surface, and
fiber wound about the exterior surface of the former to reinforce the former.

5. The accumulator of claim 4, further comprising a matrix material at least partially covering the fiber.

6. The accumulator of claim 1, wherein the inner member is cylindrical.

7. The accumulator of claim 1, wherein the inner member includes an open end providing communication between the gas-filled interior chamber of the outer vessel and the gas-receiving portion.

8. The accumulator of claim 1, wherein the inner member includes an end having a port in communication with the working fluid-receiving portion, the port extending through an opening in the outer vessel.

9. The accumulator of claim 8, wherein the port is coupled with an end cap of the inner member.

10. The accumulator of claim 8, wherein the end is a first end, and wherein the inner member further includes an open, second end providing communication between the gas-filled interior chamber of the outer vessel and the gas-receiving portion.

11. The accumulator of claim 1, wherein the inner member includes a wall having an exterior surface, wherein the outer vessel includes a wall having an interior surface, and wherein the wall of the inner member is spaced from the wall of the outer vessel such that a gap is defined between the exterior surface and the interior surface, the gap containing gas.

12. The accumulator of claim 11, further comprising at least one support member extending between the interior surface of the outer vessel wall and the exterior surface of the inner member wall for supporting the inner member within the interior chamber of the outer vessel.

13. The accumulator of claim 1, further comprising a piston positioned within the inner member separating the gas-receiving portion from the working fluid-receiving portion.

14. The accumulator of claim 1, further comprising a bladder positioned within the inner member, the bladder defining a bladder interior in fluid communication with the gas in the gas-filled interior chamber of the outer vessel, and a bladder exterior surface,
wherein the bladder interior defines the gas-receiving portion, and wherein a space between the bladder exterior surface and an interior surface of the inner member defines the working fluid-receiving portion.

15. The accumulator of claim 14, wherein the inner member includes an open end, the bladder being sealed to the open end such that gas in the bladder interior and in the interior chamber of the outer vessel is prevented from entering the working fluid-receiving portion.

16. The accumulator of claim 1, wherein the inner member is a first inner member, and wherein the accumulator further comprises
a second inner member positioned in the gas-filled interior chamber, the second inner member having a gas-receiving portion in fluid communication with the gas-filled interior chamber of the outer vessel for receiving gas, and a working fluid-receiving portion separate from the gas-receiving portion for receiving working fluid; and
wherein the working fluid-receiving portion of the first inner member and the working fluid-receiving portion of the second inner member are separate from each other within the outer vessel.

17. The accumulator of claim 16, wherein each inner member includes an end having a port in communication with the respective working fluid-receiving portion, each port extending through a respective opening in the outer vessel.

18. The accumulator of claim 17, wherein each port is coupled with a respective end wall of the respective inner member.

19. An accumulator comprising:
an outer vessel defining a gas-filled interior chamber;
an inner member positioned in the gas-filled interior chamber; and
a bladder positioned within the inner member, the bladder defining a bladder interior in fluid communication with the gas in the gas-filled interior chamber of the outer vessel; and
a working fluid-receiving space between the bladder and an interior surface of the inner member that is fluidly isolated from the bladder interior.

20. An accumulator comprising:
an outer vessel defining a gas-filled interior chamber;
a first inner member positioned in the gas-filled interior chamber, the first inner member having a gas-receiving portion in fluid communication with the gas-filled interior chamber of the outer vessel for receiving gas, and a working fluid-receiving portion separate from the gas-receiving portion for receiving working fluid; and
a second inner member positioned in the gas-filled interior chamber, the second inner member having a gas-receiving portion in fluid communication with the gas-filled interior chamber of the outer vessel for receiving gas, and a working fluid-receiving portion separate from the gas-receiving portion for receiving working fluid;
wherein the working fluid-receiving portion of the first inner member and the working fluid-receiving portion of the second inner member are separate from each other within the outer vessel.
